(19) United States
(12) Patent Application Publication
(10) Pub. No.: US 2021/0316369 A1
(43) Pub. Date: Oct. 14, 2021

(54) POWDER BED FUSION APPARATUS AND METHODS

(71) Applicant: RENISHAW PLC, Wotton-under-Edge, Gloucestershire (GB)

(72) Inventor: Nneji KEMAKOLAM, Bath (GB)

(73) Assignee: RENISHAW PLC, Wotton-Under-Edge, Gloucestershire (GB)

(21) Appl. No.: 17/259,118

(22) PCT Filed: Jul. 31, 2019
(86) PCT No.: PCT/GB2019/052139

§ 371 Date: Jan. 8, 2021

(30) Foreign Application Priority Data
Aug. 3, 2018 (EP) 18187265.6

(51) Int. Cl. B22F 12/20; B33Y 30/00; B22F 12/17; B22F 12/57; B33Y 40/00

(52) U.S. Cl. CPC B22F 12/20; B33Y 30/00; B33Y 40/00; B22F 12/57; B22F 12/17

(57) ABSTRACT

A powder bed fusion apparatus in which an object is built in a layer-by-layer manner. The apparatus has a build sleeve and a build platform for supporting a powder bed, the build platform lowerable in the build sleeve. A processing plate is coupled to an upper end of the build sleeve. The apparatus further has a doser for dosing powder and a recoater for spreading the dosed powder across the processing plate to the powder bed. A heater is provided for heating the powder bed. An active cooling device having a cooling element and/or cooling channel is to form, in use, an active thermal barrier to conduction of heat from the build sleeve through the processing plate.

### FIELD OF INVENTION

This invention concerns powder bed fusion apparatus and methods in which selected areas of a powder bed are solidified in a layer-by-layer manner to form a workpiece. The invention has particular, but not exclusive application, to selective laser melting (SLM) and selective laser sintering (SLS) apparatus.

### BACKGROUND

Powder bed fusion apparatus produce objects through layer-by-layer solidification of a material, such as a metal powder material, using a high-energy beam, such as a laser or electron beam. A powder layer is formed across a powder bed contained in a build sleeve by lowering a build platform to lower the powder bed, depositing a heap of powder adjacent to the lowered powder bed and spreading the heap of powder with a recoater across (from one side to another side of) the powder bed to form the layer. Portions of the powder layer corresponding to a cross-section of the workpiece to be formed are then solidified through irradiating these areas with the beam. The beam melts or sinters the powder to form a solidified layer. After selective solidification of a layer, the powder bed is lowered by a thickness of the newly solidified layer and a further layer of powder is spread over the surface and solidified, as required.

An example of such a device is disclosed in U.S. Pat. No. 6,042,774. The build platform disclosed in U.S. Pat. No. 6,042,774 comprises a cooling conduit formed of meandering loops of a copper tube. The build platform is cooled during the entire building process. A gap between the edge of the build platform and the inner wall of the container is sealed by a flexible sealing lip surrounding the outer edge of the build platform.

US2004/0056022 A1 discloses a heating plate that is placed in the building platform or integrated in the surface of the building platform. The heating plate is designed and thermally insulated from the building platform by an insulation layer in such a manner that is reaches temperatures of at least 500° C. during heating. The heating plate is placed at a distance from the side walls. Insulation between the hot component and the side walls of the construction chamber is assumed by the surrounding powder, because the thermal conductivity of spread powder is very low. With the device, metallic components are maintained at temperatures above 500° C. during the building process thereby reducing the danger of tensions or cracking in the component.

US2007/0023977 A1 discloses a device comprising a heating plate which can heat up to an operating temperature of between 300° C. and 500° C. The building platform has cooling passages which extend transversely throughout the entire building platform. At least one inlet opening is provided in a peripheral wall of the build chamber. Ambient air is fed to the build chamber through the inlet opening. The build chamber also has at least one outlet opening connected to a discharge line.

After completion of a build, a carrier is lowered into a cooling position in which the cooling passages of the building platform are aligned with the inlet opening and the outlet opening in the peripheral wall of the build chamber. A volumetric flow flows through the cooling passages, thereby cooling at least the build platform. The cooling may be affected by a pulsed suction stream.

In addition, US2007/0023977 A1 discloses the provision of cooling passages or cooling hoses adjacent to the peripheral wall of the build chamber or in the peripheral wall of the build chamber, these cooling passages or cooling hoses contributing to cooling of the build chamber, the moulded body and the carrier.

WO2010/007394 A1 discloses apparatus in which an inert atmosphere can be maintained both above and below the build platform, i.e. on both sides of the seal formed between the build platform and the build cylinder. By controlling the atmosphere both above and below the build platform to have the same pressure the problem of powder being naturally forced between the seal and a bore of the build cylinder can be mitigated. A vacuum or reduced pressure atmosphere can be formed both above and below the build platform. In use, the atmosphere both above and below the build platform is degassed to a rough vacuum and, once the atmosphere has been degassed, the chambers backfilled with argon. Such a method of forming an inert atmosphere may achieve lower oxygen levels at the start of the build than methods in which the inert atmosphere is formed by flushing a chamber with an inert gas without first forming a vacuum or reduced pressure atmosphere.

US2018/0079033 A1 discloses a plant for additive production of parts by laser melting. The powder bed is formed on a build platform, which via an actuator in a cup-shaped housing can be lowered in steps by a powder layer thickness in each case. In the housing and the build platform, heating devices in the form of electric resistance heaters can preheat the component being formed and the particles of the powder bed.

US2010/0101490 A1 discloses a laser sintering device for manufacturing a three-dimensional object. The laser sintering device comprises a frame which opens in the upper side and has therein a platform, which is movable in the vertical direction and supports the three-dimensional object to be manufactured. The frame and the platform define inside a building space. At the inner side facing the building space, the frame comprises glass ceramic plates. At an outer side of the glass ceramic plates averted from the building space, the frame further has surface heating elements.

### SUMMARY OF THE INVENTION

According to a first aspect of the invention there is provided a powder bed fusion apparatus in which an object is built in a layer-by-layer manner, the apparatus comprising a build sleeve, a build platform for supporting a powder bed, the build platform lowerable in the build sleeve, a processing plate coupled with an upper end of the build sleeve, a doser for dosing powder and a recoater for spreading the dosed powder across the processing plate to the powder bed. The powder bed fusion apparatus may comprise a heater for heating the powder bed. The powder bed fusion apparatus may comprise an active cooling device comprising a cooling element and/or a cooling channel to, in use, form an active thermal barrier to conduction of heat from the build sleeve through the processing plate.

A powder bed fusion apparatus may comprise components, such as arms of the recoater and/or walls of a build chamber, that may not operate satisfactorily if heated to the temperatures that are of the order of the temperature of the powder bed during powder bed fusion. For example, the powder bed may be heated to temperatures above 500° C., above 800° C. or 1000° C. The active thermal barrier acts to protect these components from the heat of the powder bed. The build sleeve is typically suspended from the processing plate, which acts to separate other components of the apparatus from the build sleeve. Therefore, limiting heat conduction through the processing plate, aids in the thermal isolation of the other components of the apparatus from the heated powder bed. Furthermore, as the processing plate is a separate component to the build sleeve, differential thermal expansion can occur between the hotter build sleeve and the cooler processing plate without the creation of stresses that could otherwise damage the apparatus.

The cooling element and/or cooling channel may at least partially surround the perimeter (in a plane parallel with the plane of processing plate) of an upper end of the build sleeve. The upper end of the build sleeve may be partially surrounded by elements that suppress conduction of heat away from the build sleeve, for example, powder overflow channels around the build sleeve and/or a cooled gas flow delivered across the processing plate. Accordingly, the cooling element and/or cooling channel may extend at least around other sections of the outer perimeter of the upper end of the build sleeve that are not surrounded by these other elements that suppress conduction of heat away from the build sleeve. For example, the cooling element and/or cooling channel may surround at least one quarter of the outer perimeter of the upper end of the build sleeve. This may be appropriate when powder overflow channels are provided extending along two other quarters and cooled gas flow is provided from a gas nozzle extending along a further quarter of the outer perimeter of the upper end of the build sleeve. Alternatively, only one powder overflow channel may be provided, or the gas flow may not be cooled and therefore, the cooling element and/or cooling channel may be provided around half or three-quarters of the outer perimeter that is not surrounded by the overflow channel(s)/gas flow nozzle. Preferably, the cooling element/cooling channel surrounds substantially all the outer perimeter of the upper end of the build sleeve. The cooling element and/or cooling channel may be arranged to, in use, form an active thermal barrier to conduction of heat from the build sleeve to a majority of the processing plate.

The cooling element may contact the processing plate in a region at least partially surrounding the build sleeve. The cooling element may contact a bottom surface of the processing plate, may be located, for example sandwiched, between the processing plate and the upper end of the build sleeve or may be embedded within the processing plate.

The cooling element may comprise a (highly) thermally conductive element, for example an element made of a material in which the main component is one of copper, aluminium, gold and silver, cooled by a cooling source which removes heat from the cooling element. For example, the cooling source may be a flow of a coolant, a Peltier device or the like.

The cooling channel may be formed by holes in the processing plate, the cooling channel arranged to carry a coolant. Alternatively, the cooling element may comprise a conduit, such as piping, for carrying coolant. The cooling channel may be arranged for carrying a coolant. The cooling device may comprise a chiller for cooling the coolant, the conduit and/or cooling channel forming part of a circuit for recirculating the coolant through the chiller.

The cooling element and/or cooling channel may comprise a loop that surrounds substantially the entire perimeter of the upper end of the build sleeve. The cooling element and/or cooling channel may comprise a plurality of loops, each loop of the plurality of loops surrounding the upper end of the build sleeve.

The processing plate may have a powder opening for receiving excess powder that remains after spreading of one or more layers by the recoater. The cooling element and/or cooling channel may extend between the build sleeve and the powder opening. In the case that the cooling element and/or cooling channel are arranged to carry a coolant, a first half of the loop (in the direction of coolant flow) may comprise a section of the loop between the powder opening and the build sleeve. In this way, cooling through the coolant is focussed on a thinner section of the processing plate between the build sleeve and the powder opening above other wider parts of processing plate that are less likely to warp under thermal stress.

The powder opening may be a powder overflow or an opening of the doser for dosing powder, for example a piston doser.

The powder opening may be arranged on an opposite of the build sleeve to the dosing position. Alternatively, the recoater may comprise a mechanism for spreading a dose of powder in alternate directions across the powder bed, such as disclosed in EP1189716 or EP1771267, and the dosing position is the same side of the build sleeve as the powder opening, between the powder opening and the build sleeve.

In one embodiment, the doser may be arranged to dose powder at a dosing position and the recoater is arranged to spread the dose of powder from the dosing position across the powder bed. The cooling element and/or cooling channel may be arranged such that powder can be spread by the recoater between a dosing position and the powder bed without passing over the cooling element and/or cooling channel. The cooling element and/or cooling channel may surround an area including the build sleeve and an area across which powder is spread by the recoater between the dosing position and the powder bed. It may be undesirable to cool a portion of the processing plate across which the powder is spread, for example because the dosed powder is preheated before being formed into a layer of the powder bed. Accordingly, the thermal barrier may be provided outside of this powder spreading region. The powder bed fusion apparatus may comprise a local heater for heating powder localised on a region of the processing plate. For example, the heater may be integrally mounted within the recoater or a local surface heater mounted in a fixed location relative to the processing plate for heating powder as it is spread by the recoater and/or when the powder is in the dosing position.

The processing plate may be directly or indirectly coupled to the build sleeve such that powder can be spread by the recoater from the processing plate to the powder bed. For example, the processing plate may be indirectly coupled to the build sleeve via an intermediate member, such as a further, intermediate processing plate or the cooling element.

### DESCRIPTION OF THE DRAWINGS

FIG. 1 is a schematic cross-sectional view of a powder bed fusion apparatus according to a first embodiment of the invention;

FIG. 2 is a plan view of a processing plane of the powder bed fusion apparatus shown in FIG. 1;

FIG. 3 is a schematic cross-sectional view of a powder bed fusion apparatus according to a second embodiment of the invention;

FIG. 4 is a plan view of a processing plane of the powder bed fusion apparatus shown in FIG. 3; and

FIG. 5. is a plan view of a processing plane of the powder bed fusion apparatus according to another embodiment of the invention.

### DESCRIPTION OF THE EMBODIMENTS

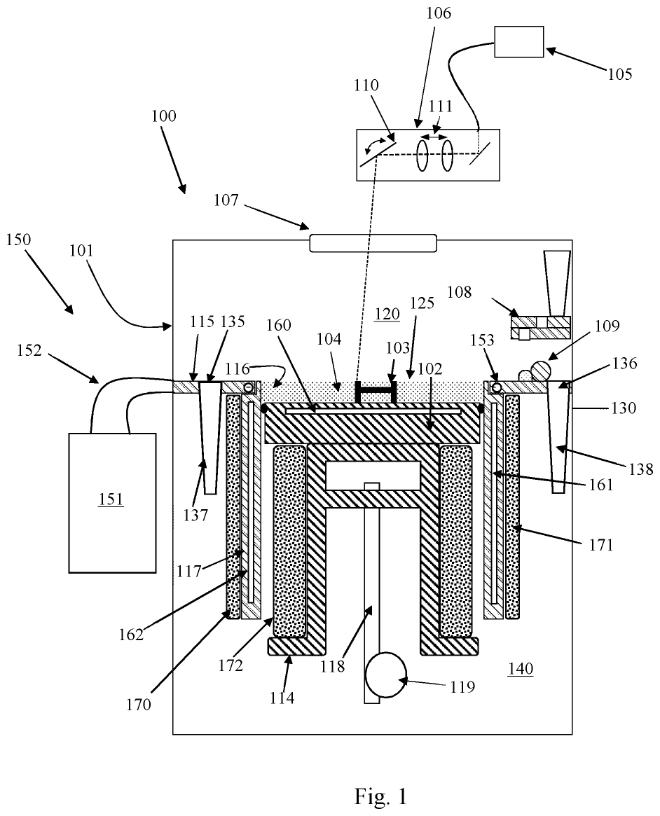

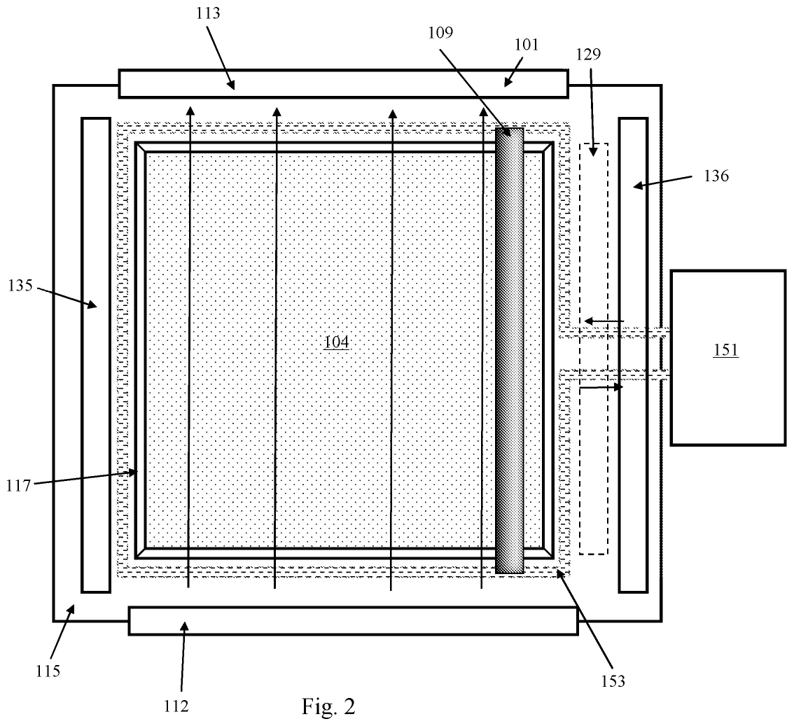

With reference to FIGS. 1 and 2, a powder bed fusion apparatus 100 according to an embodiment of the invention includes a build chamber 101 that can be sealed from the external environment. The build chamber 101 is divided into an upper processing chamber 120 and a lower chamber 140 by a processing plate 115 and a build platform 102 reciprocally movable within a bore 116 of a build sleeve 117.

The build platform 102 is moved by an elevator mechanism 118, 119 located in the lower chamber 140. In this embodiment, the build platform 102 is connected to a lead screw 118 of a drive mechanism by an A-shaped frame 114, which acts to insulate the lead screw 118 from the build platform 102. The A-frame 114 may be cooled, for example by a coolant flowing in a coolant line (not shown). Surrounding the A-frame 114 is insulation 172, for example carbon hardboard, for insulating the A-frame 114 and lead screw 118 from the hot walls of the build sleeve 117. The lead screw 118 is driven by drive 119.

The build platform 102 is sealably engaged with the bore 116 of the build sleeve 117 to prevent egress of powder into the lower chamber 140. This is achieved by seal 130, associated with an edge of the build platform 102, which physically engages with the bore 116 of the build sleeve 117. The processing plate 115, build sleeve 117, build platform 102 and associated seal 130 function to form a barrier for the powder such that the powder remains in the processing chamber 120 and does not travel to the lower chamber 140.

A rim of the build sleeve 117 comprises a stepped section including a shoulder and an inset collar that form a surface and abutment against which the processing plate 115 is engaged for coupling the processing plate 115 to the build sleeve 117. In this embodiment, the build sleeve 117 has a square horizontal cross-section formed of four walls secured together. Embedded within each wall is a resistive heater 161, 162 for heating a powder bed 104. A further resistive heater 160, for heating an object 103 as it is built and the powder bed 104, is provided in the build platform 102. The mounting of the processing plate 115 onto the build sleeve 117 allows differential thermal expansion between the two components. In this embodiment, both the build sleeve 117 and the processing plate 115 are made of steel sheets.

The powder bed fusion apparatus comprises a cooling device 150 for cooling the processing plate 115. The cooling device 150 comprises a cooling element 153 inserted into a channel in the processing plate 115 that is open to an underside of the processing plate 115. The cooling element is actively cooled by a chiller 151. In this embodiment, the cooling element is in the form of a conduit 153 for carrying a coolant, which flows under the control of a pump (not shown) in a circuit through the conduit 153 and a chiller 151. The coolant flows between the conduit 153 and the chiller 151 via supply and return lines 152. In this embodiment, the conduit forms a loop that substantially surrounds the build sleeve 117 to form, in use, an active thermal barrier to conduction of heat from the build sleeve 117 through the processing plate 115. The conduit 153 is copper piping, which provides good thermal conductivity for the conduction of heat to the coolant.

In another embodiment, the cooling channels are formed directly into the processing plate 115. For example, cooling channels may be formed by cross-drilling holes into the processing plate 115 and then sealing openings to form a single coolant circuit. Forming the cooling channels directly into the processing plate 115 may reduce the risk of coolant leaks compared to the use of a separate conduit.

In this embodiment the coolant is water. However, for higher temperature applications it may be desirable to use a coolant such as oil or a gas, such as air, nitrogen, argon and/or a cryogenic gas.

The processing chamber 120 encloses a working plane 135 to which one or more energy beams, in this embodiment a laser beam, is directed to fuse powder of the powder bed 104 to form a three-dimensional object 103. The processing chamber 120 is arranged to maintain an inert atmosphere around the working plane 125. The processing chamber 120 houses a doser 108 for dosing powder to be formed into layers to a dosing position 129 on the processing plate 115 and a recoater 109 for spreading each dose of powder from the dosing position 129 into one or more layers of powder over the build platform 102/powder bed 104. The doser may comprise a dosing mechanism as described in WO2010/007396. In this embodiment, the recoater 108 spreads the dose of powder in a single direction. Openings 135, 136 are provided in the processing plate 115 on opposite sides of the build sleeve 117 in a powder spreading direction. Each opening 135, 136 is connected to a powder collection hopper 137, 138 for capturing excess powder that remains in front of the recoater 109 after the spreading of a powder layer or is picked up on a return stroke of the recoater 109. Preferably, both openings 135, 136 lead to the same collection hopper.

In the first embodiment, the dosing position 129 is on a portion of the processing plate 115 that falls outside of an area surrounded by the conduit 153. Accordingly, the dosing position is on a “cold” portion of the processing plate 115. The openings 135 and 136 are also located outside of the area surrounded by the conduit 153 and thus, are also in a “cold” portion of the processing plate 115. The flow of coolant through the conduit 153 is in a direction such that the coolant passes through a thinner section of the processing plate 115 between the build sleeve 117 and the opening 135 before passing through other wider sections of the processing plate 115. Such narrower sections of the processing plate 115 are likely to dissipate heat more slowly than wider areas of the processing plate 115 because of the narrow routes for the conduction of heat away from these sections (the opening 135, in particular, providing a thermal barrier to conduction from the portion of the processing plate 115 between the opening 135 and the build sleeve 117). By passing the coolant first through such narrower section of the processing plate 117 before passing the coolant through wider section of the processing plate 117 the cooling of these potentially hotter narrower regions is prioritised.

Insulation 170, 171, such as carbon hardboard, is provided around the build sleeve 117 for maintaining the heat within the build volume.

Optical access to the processing chamber 120 for a high-powered laser beam is provided via window 107. A high-powered laser beam can be directed from laser 105 through the window 107 by a scanner 106 for scanning the laser beam over the working plane 125 to consolidate successive layers of powder. The scanner 106 comprises two steering mirrors (only one 110 of which is shown) and focussing optics 111.

In this embodiment, the lower chamber 140 is sealable from the external environment as part of the internal volume of the build chamber 101. However, it will be understood that in another embodiment, a region below the processing plate 115 and the build platform 102 may not be sealable from the external environment and, in such an embodiment, the seal 130 and or another seal about the build platform 102 acts as a gas seal to maintain the desired (inert) atmosphere in the processing chamber 120.

The upper and lower chambers 120, 140 are coupled to each other via an opening (not shown), which allows the pressure in the chambers 120, 140 to be equalised. Preferably there is a filter (not shown) within the opening to prevent powder and soot from entering the lower chamber. This arrangement provides the advantage that the pressure immediately above and below the build platform 102 may be maintained at the same level such that powder is not forced past the seal 130.

The powder bed fusion apparatus comprises a gas flow circuit for forming the inert atmosphere and a gas knife as described in WO2016/079494, which is incorporated herein by reference. The gas knife is formed between a gas nozzle 112 and a gas exhaust 113 in a direction (as shown by the arrows over the powder bed 104) perpendicular to the direction of movement of the recoater 109. The gas flow circuit may cool the gas recirculated through the gas flow circuit and inject the cooled gas into the processing chamber 120, for example as described in WO2016/102970.

In use, during heating of the powder bed 104 by heaters 160, 161, 162, coolant is circulated through conduit 153 to cool the processing plate 115 in the region of the conduit 153. This cooled region acts as a thermal barrier to the conduction of heat from the build sleeve 117 to other components of the powder bed fusion apparatus. In this way, damage to these other components is avoided.

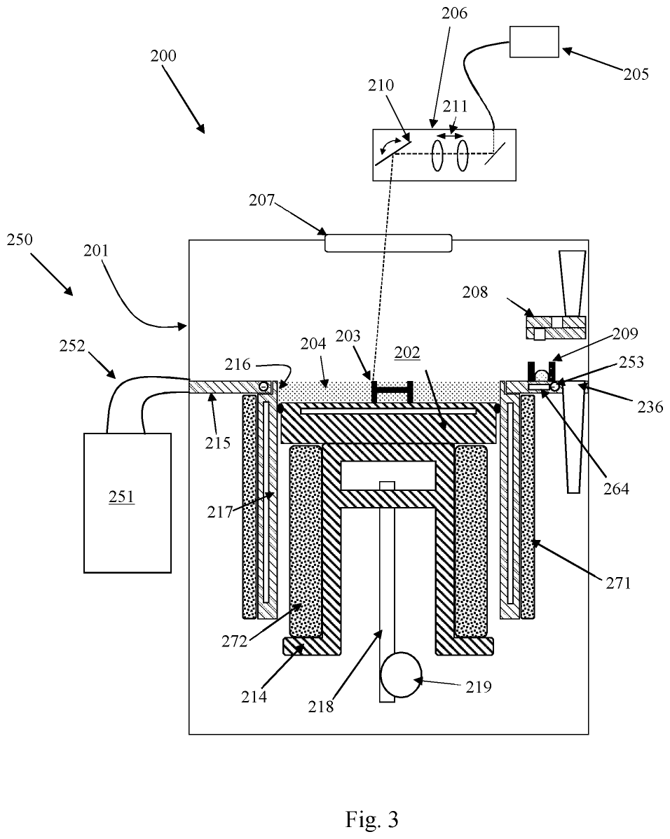

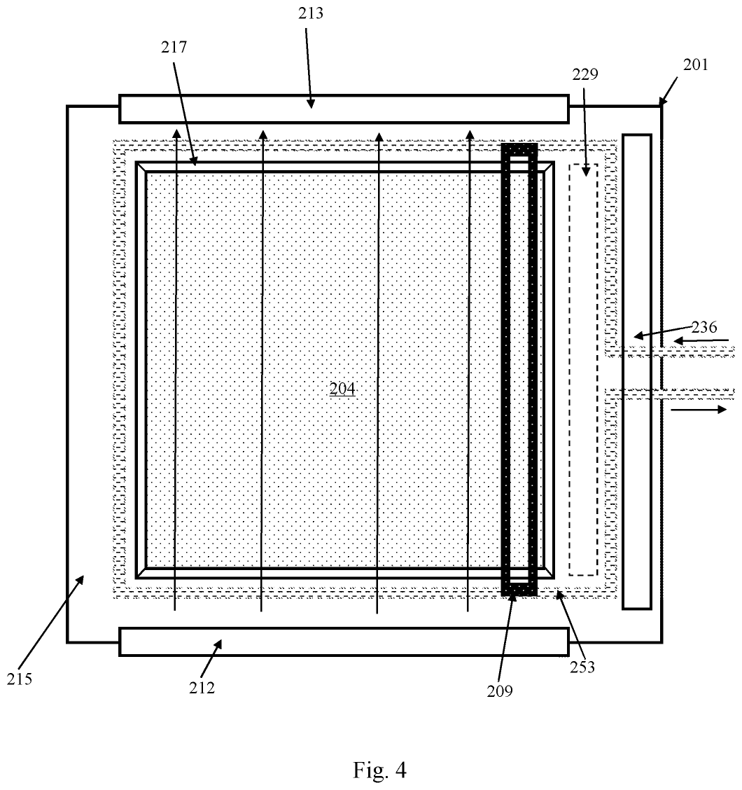

Referring to FIGS. 3 and 4 a further embodiment of the invention is shown. Features of this embodiment corresponding to similar or like features of the embodiment described above with reference to FIGS. 1 and 2 have been given the same reference numerals but in the series 200. Differences between this embodiment and the previously described embodiment are described below. For description of other features that are the same in both embodiments, reference is made to be above description of these features with reference to FIGS. 1 and 2.

The second embodiment differs from the first embodiment in that the recoater 209 comprises a dual wiper system in which powder can be spread across the powder bed in both directions. For example, the dual recoater may be as described in EP1189716. As powder can now be spread in both directions, only a single opening 236 is provided in the processing plate 215.

The powder fusion apparatus further comprises a heater 264, such as a resistive heater, embedded within the processing plate 215 for heating the powder in the dosing position 229 before it is spread across the powder bed 204. For example, the recoater powder heating system may be as described in WO2017/008890. In another embodiment, the heater is provided in the recoater for heating the powder as it is spread across the powder bed 104. The conduit 253 is arranged in the processing plate 115 to surround both the build sleeve 217 and the dosing position 229. In this way, the conduit 253 carrying coolant cools the processing plate 215 to provide a thermal barrier to conduction of heat from the build sleeve and the “hot” region of the processing plate 215 heated by heater 264.

Preheating of the powder before the powder is spread into a layer may facilitate the building process as it ensures that the newly spread powder is closer to or at the required temperature for fusion immediately after the layer has been spread.

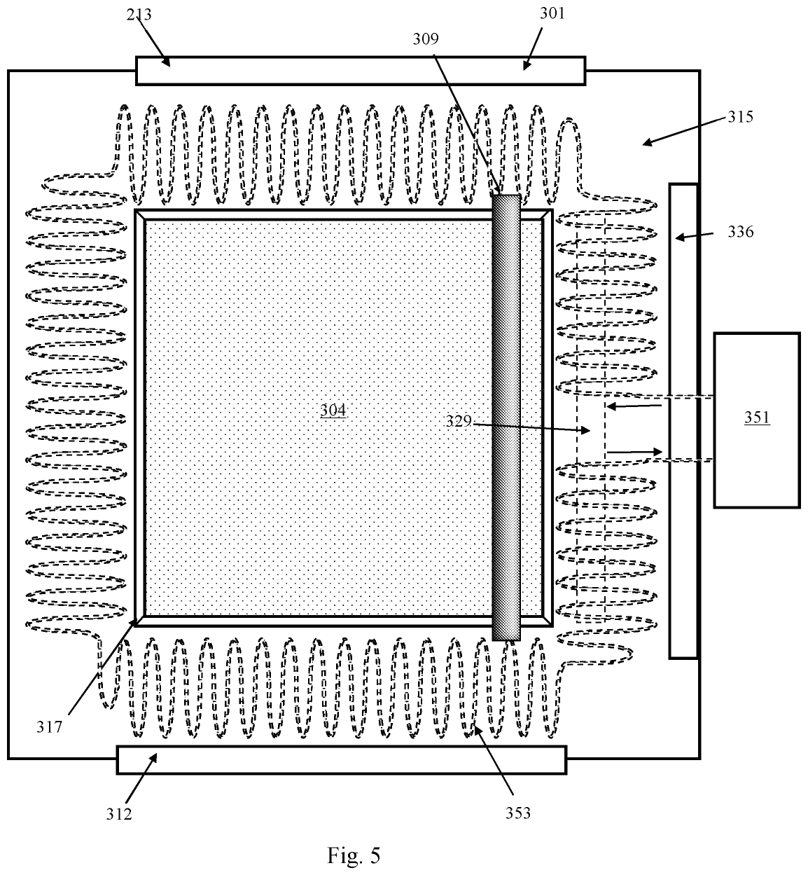

Referring to FIG. 5, a further embodiment of the invention is shown. Features of this embodiment corresponding to similar or like features of the embodiments described above with reference to FIGS. 1 to 4 have been given the same reference numerals but in the series 300. Differences between this embodiment and the previously described embodiment are described below. For description of other features that are the same in both embodiments, reference is made to be above description of these features with reference to FIGS. 1 to 4.

In this embodiment, the processing plate 315 is built with the cooling channels 353 integrally formed therein. For example, the processing plate 353 may be built by additive manufacturing or vacuum brazing. In this way, more complex shaped cooling channels 353 can be formed without significantly compromising the mechanical stability of the processing plate 315. In this embodiment, the cooling channels are formed as a series of coils formed in a common plane, the coils arranged in a loop around the build sleeve 317. Such an arrangement may be used to cool a greater surface area of the processing plate 315 to provide a wider thermal barrier to heat conduction from the build sleeve 317. In a further embodiment, an areal cooling channel is provided, wherein a cooling channel in the processing plate defines a cooling chamber having a width greater than its height. Fins or columns may be provided between the floor and ceiling of the cooling chamber to provide sufficient structural integrity to the processing plate 115.

It will be understood that modifications and alterations can be made to the above described embodiments without departing from the invention as defined herein.

For example, heating of the powder bed may be carried out by means other than resistive heaters, for example by induction heating as described in US2013/0309420 or microwave heating as described in WO2016/051163.

Furthermore, apparatus for thermally protecting components from heat generated at the powder bed may be used with powder bed fusion apparatus without means for preheating the powder bed. For example, in a multi-laser powder bed fusion apparatus, an amount of energy can be delivered to the powder bed in a short period of time causing significant heating of the powder bed/build volume. Accordingly, means, such as those described above, may be required for protecting components within the build chamber from this heat.

Rather than using a top doser 108, 208 as described above, a bottom doser may be used, which doses powder through an opening in the processing plate, such as a piston dosing mechanism. The cooling element/cooling channel may extend between the bottom doser and the build sleeve or surround both the build sleeve and the bottom doser. The latter may be desirable if the powder is to be preheated in the dosing piston. The powder may be preheated in the dosing piston to a lower temperature than the temperature to which it is heated in the build sleeve to avoid agglomeration or bonding of the powder in the dosing piston.

1. A powder bed fusion apparatus in which an object is built in a layer-by-layer manner, the apparatus comprising a build sleeve, a build platform for supporting a powder bed, the build platform lowerable in the build sleeve, a processing plate coupled to an upper end of the build sleeve, the processing plate being a separate component to the build sleeve, a doser for dosing powder, a recoater for spreading the dosed powder across the processing plate to the powder bed, a heater for heating the powder bed and an active cooling device comprising a cooling element and/or cooling channel to, in use, form an active thermal barrier to conduction of heat from the build sleeve through the processing plate.

2. A powder bed fusion apparatus according to claim 1, wherein the cooling element and/or cooling channel at least partially surrounds the upper end of the build sleeve.

3. A powder bed fusion apparatus according to claim 1, wherein the cooling element contacts the processing plate.

4. A powder bed fusion apparatus according to claim 3, wherein the cooling element contacts a bottom surface of the processing plate.

5. A powder bed fusion apparatus according to claim 1, wherein the cooling element and/or cooling channel is located between the processing plate and the upper end of the build sleeve.

6. A powder bed fusion apparatus according to claim 1, wherein the cooling element is embedded within the processing plate.

7. A powder bed fusion apparatus according to claim 1, wherein the cooling channel is formed by holes within the processing plate.

8. A powder bed fusion apparatus according to claim 1, wherein the cooling element comprises a thermally conductive element cooled by a cooling source which removes heat from the cooling element.

9. A powder bed fusion apparatus according to claim 1, wherein the cooling element comprises a conduit for carrying coolant and/or the cooling channel is arranged to carry a coolant.

10. A powder bed fusion apparatus according to claim 9, wherein the cooling device comprises a chiller for cooling the coolant, the conduit and/or cooling channel forming part of a circuit for recirculating the coolant through the chiller.

11. A powder bed fusion apparatus according to claim 1, wherein the cooling element and/or cooling channel comprises a loop that extends around the build sleeve.

12. A powder bed fusion apparatus according to claim 11, wherein the cooling element and/or cooling channel comprises a plurality of loops.

13. A powder bed fusion apparatus according to claim 1, wherein the processing plate has a powder opening for receiving excess powder that remains after spreading of one or more layers by the recoater and the cooling element and/or cooling channel extends between the build sleeve and the powder opening, wherein the powder opening may be a powder overflow or an opening of a doser for dosing powder.

14. A powder bed fusion apparatus according to claim 1, wherein the cooling element and/or cooling channel is arranged such that powder can be spread by the recoater between a dosing position and the powder bed without passing over the cooling element and/or cooling channel.

15. A powder bed fusion apparatus according to claim 1, wherein the processing plate is built using an additive manufacturing method, with the cooling channels contained therein.
